(19) United States
(12) Patent Application Publication
(10) Pub. No.: US 2026/0031438 A1
(43) Pub. Date: Jan. 29, 2026

(54) Pouch-type secondary battery and method for manufacturing the same

(71) Applicant: SK ON CO., LTD., Seoul (KR)

(72) Inventors: Sung-Hee MIN, Daejeon (KR); Young Ha KIM, Daejeon (KR); Ga Yeong YOO, Daejeon (KR); Min Jae LEE, Daejeon (KR); Ho Jin HWANG, Daejeon (KR)

(21) Appl. No.: 19/280,116

(22) Filed: Jul. 25, 2025

(30) Foreign Application Priority Data
Jul. 26, 2024 (KR) 10-2024-0099086

(51) Int. Cl. H01M 50/105; H01M 50/186; H01M 50/474; H01M 50/477

(52) U.S. Cl. CPC H01M 50/105; H01M 50/186; H01M 50/474; H01M 50/477

(57) ABSTRACT

Provided is a pouch-type secondary battery including a pouch case accommodating an electrode assembly inside, a sealing portion formed at an edge of the pouch case to seal the electrode assembly, and a partition plate accommodated inside the pouch case and facing the sealing portion, wherein the pouch case is bent at a corner of the partition plate to form the sealing portion.

### CROSS-REFERENCE TO RELATED APPLICATIONS

This application claims priority under 35 U.S.C. § 119 to Korean Patent Application No. 10-2024-0099086, filed on Jul. 26, 2024, in the Korean Intellectual Property Office, the disclosure of which is incorporated herein by reference in its entirety.

### TECHNICAL FIELD

The following disclosure relates to a pouch-type secondary battery and a method for manufacturing the same, and in particular, to a pouch-type secondary battery stably folded without cracks and a method for manufacturing the same.

### BACKGROUND

Secondary batteries are electrochemical energy storage devices that may repeatedly perform charging and discharging and have been used in various fields, such as automobiles and energy storage systems. Secondary batteries are expected to play an essential role in the sustainable development of future society, and thus, technology related secondary batteries has been continuously developed. In particular, development of secondary batteries has been actively conducted to achieve high energy density, long lifespan, high safety, etc.

A general pouch-type secondary battery may have a structure in which an electrode assembly is wrapped with an outer casing, such as a pouch. At this time, the outer casing is sealed by sealing the outermost portion of the outer casing in which the electrode assembly is accommodated, and here, if the secondary battery module is assembled with the sealing portion protruding, the total volume of the secondary battery module may increase due to the sealing portion, and thus the energy density of the secondary battery module may decrease.

Therefore, as shown in FIG. 1, in order to minimize the volume occupied by the sealing portion protruding from the outer casing, the sealing portion of the pouch-type secondary battery is generally folded several times. However, folding the sealing portion several times has problems, such as concentration of stress in a folded region, reduced outer casing strength, formation of cracks that destroy the insulation, etc.

### SUMMARY

An exemplary embodiment of the present disclosure is directed to providing a pouch-type secondary battery with improved mechanical stability.

An exemplary embodiment of the present disclosure is also directed to providing a pouch-type secondary battery with improved energy density.

An exemplary embodiment of the present disclosure is also directed to providing a pouch-type secondary battery with improved manufacturing convenience.

The pouch-type secondary battery of the present disclosure and the manufacturing method thereof may be widely applied to green technology fields, such as electric vehicles, battery charging stations, and other solar power generation and wind power generation using batteries. In addition, the pouch-type secondary battery of the present disclosure and the manufacturing method thereof may be used in eco-friendly electric vehicles, hybrid vehicles, etc. to prevent climate change by suppressing air pollution and greenhouse gas emissions.

The tasks of the present disclosure are not limited to the tasks mentioned above, and other tasks not mentioned may be clearly understood by those skilled in the art from the description below.

In one general aspect, a pouch-type secondary battery includes: a pouch case accommodating an electrode assembly inside; a sealing portion formed at an edge of the pouch case to seal the electrode assembly; and a partition plate accommodated inside the pouch case, one surface of the partition plate facing the sealing portion and the other surface of the partition plate facing the electrode assembly, wherein the pouch case may be bent at a corner of the partition plate to form the sealing portion.

The pouch case may include an upper pouch wrapping around an upper surface of the electrode assembly and a lower pouch wrapping around a lower surface of the electrode assembly, and one edge of the upper pouch and one edge of the lower pouch may be bent and then overlap each other to form the sealing portion.

The partition plate may be disposed such that an upper end contacts the upper pouch and a lower end contacts the lower pouch.

The upper pouch may be bent at an upper corner of the partition plate, the lower pouch may be bent at a lower corner of the partition plate, and the sealing portion may be formed as an outer surface of one selected from the upper pouch and the lower pouch and an inner surface of the other one contact and overlap each other.

At least a portion of a region in which the upper pouch and the lower pouch overlap may be provided with a bonding agent.

When a height of the pouch case may be H, a length of the region in which the upper pouch and the lower pouch overlap in a height direction may be 0.5 H or more and 1.0 H or less.

An angle at which the upper pouch and the lower pouch are bent may be 60° or more and 90° or less.

The partition plate may have a plurality of holes formed in a pattern, and the plurality of holes may be gas permeable or liquid impermeable.

In another general aspect, a method for manufacturing a pouch-type secondary battery includes: an accommodating operation of accommodating an electrode assembly in a cup portion of a pouch case; a partition plate inserting operation of inserting a partition plate into the cup portion; a temporary sealing operation of temporarily sealing an edge of the pouch case located outside the partition plate to form a temporary sealing portion; a cutting operation of cutting the temporary sealing portion; a folding operation of bending the pouch case at a corner of the partition plate; and a sealing operation of sealing an overlapping region formed as the pouch case is bent.

The pouch case may include an upper pouch and a lower pouch, and in the folding operation, the upper pouch may be bent at an upper corner of the partition plate and the lower pouch may be bent at a lower corner of the partition plate to form an overlapping region in which the upper pouch and the lower pouch overlap each other by a predetermined region, and the overlapping region may be formed as an outer surface of one selected from the upper pouch and the lower pouch and an inner surface of the other one are in contact with each other.

The method may further include a degassing operation of degassing gas generated after the electrode assembly is accommodated after the cutting operation, wherein the gas is discharged to the outside through the partition plate.

The partition plate may have a plurality of holes formed in a pattern, and the holes may be gas permeable or liquid impermeable.

In the folding operation, an angle at which the upper pouch and the lower pouch are bent may be 60° or more and 90° or less.

The method may further include: a cup forming operation of forming a cup portion in which the electrode assembly may be seated in the lower pouch, wherein, in the cup forming operation, the cup portion is formed by unforming one surface of the lower pouch and forming the remaining surface, and in the partition plate inserting operation, the partition plate may be disposed adjacent to the unformed surface of the lower pouch.

Other features and aspects will be apparent from the following detailed description, the drawings, and the claims.

### BRIEF DESCRIPTION OF THE DRAWINGS

FIG. 1 is a diagram illustrating a folded state of a sealing portion of the related art pouch-type secondary battery.

FIG. 2 is a perspective view of a pouch-type secondary battery according to an example of the present disclosure.

FIG. 3 is a cross-sectional view taken along line A-A′ of FIG. 2.

FIG. 4A and FIG. 4B are diagrams illustrating examples of an upper pouch and a lower pouch being bent.

FIG. 5 is a perspective view of a partition plate according to an example of the present disclosure.

FIGS. 6 and 7 are exploded perspective views of a pouch-type secondary battery.

FIGS. 8A to 8D are a cross-sectional view of a pouch-type secondary battery in the manufacturing stages as viewed from an A-A′ section of FIG. 2.

### DETAILED DESCRIPTION OF EXEMPLARY EMBODIMENTS

Hereinafter, the present disclosure will be described in detail. However, this is merely an example and the present disclosure is not limited to the specific exemplary embodiments described as examples.

The pouch-type secondary battery of the present disclosure may be widely applied to green technology fields using batteries, such as portable devices, electric vehicles, and energy storage systems. In addition, the pouch-type secondary battery of the present disclosure may be used in eco-friendly electric vehicles, hybrid vehicles, etc. to prevent climate change by suppressing air pollution and greenhouse gas emissions.

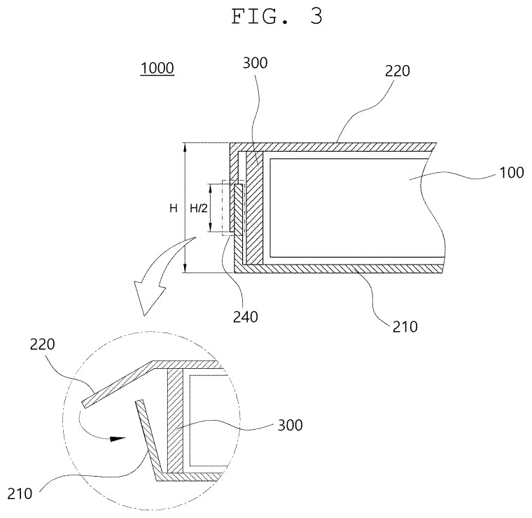

Hereinafter, a pouch-type secondary battery 1000 according to an example of the present disclosure will be described with reference to FIGS. 2 and 3. FIG. 2 is a perspective view of a pouch-type secondary battery according to an example of the present disclosure, and FIG. 3 is a cross-sectional view taken along line A-A′ of FIG. 2.

The pouch-type secondary battery according to an example of the present disclosure may include an electrode assembly 100, a pouch case 200 that accommodates the electrode assembly 100, a sealing portion 240 formed at one edge of the pouch case 200 to seal the electrode assembly 100, and a partition plate 300 accommodated inside the pouch case and facing the sealing portion 240. The pouch case 200 may be bent at a corner of the partition plate 300 to form the sealing portion 240.

The electrode assembly 100 may be formed by repeatedly arranging a positive electrode, a negative electrode, and a separator and may be accommodated inside the pouch case 200 together with an electrolyte. The electrode assembly 100 may include an electrode tab 110 that protrudes in one direction or both directions, and the positive electrode and the negative electrode may be electrically connected to the outside through the electrode tab 110. In FIG. 2, the pouch case 200 is illustrated as including the electrode assembly 100 with electrode tabs 110A and 110B protruding in both directions.

The pouch case 200 may include the electrode assembly 100 and the electrolyte inside the case. The pouch case 200 may be configured in a flexible film form to facilitate forming, folding, etc. and may be configured in a form in which, for example, materials, such as plastic and aluminum, are stacked in layers. A cup portion formed concavely may be provided at the center of the pouch case 200 so that the electrode assembly 100 may be seated at a predetermined position inside the case.

The sealing portion 240 for sealing the electrode assembly 100 may be formed at one edge of the pouch case 200. The sealing portion 240 may be formed in a portion of the edge of the pouch case excluding a portion in which the electrode tab 110 of the electrode assembly 100 protrudes.

The partition plate 300 may be accommodated inside the pouch case 200 together with the electrode assembly and may be arranged so that one surface thereof faces the sealing portion 240 and the other surface faces the electrode assembly 100. If a space in an internal space of the pouch case 200 in which the electrode assembly 100 is accommodated is referred to as an accommodation portion, the partition plate 300 may be disposed between the accommodation portion and the sealing portion 240.

The partition plate 300 may be disposed between the accommodation portion and the sealing portion 240 to physically block the accommodation portion and the sealing portion 240. The accommodation portion may accommodate an electrolyte together with the electrode assembly 100, and since the partition plate 300 is disposed between the accommodation portion and the sealing portion 240, the electrolyte may be prevented from leaking toward the sealing portion 240.

Meanwhile, the pouch case may be bent at the corner of the partition plate 300 to form the sealing portion 240, and the sealing portion will be described in detail below.

First, the pouch case 200 may include an upper pouch 220 that wraps around an upper surface of the electrode assembly 100 and a lower pouch 210 that wraps around a lower surface of the electrode assembly 100. The upper pouch and the lower pouch may be formed of an integral outer casing, and the outer casing may be bent based on the electrode assembly, and one bent side may be formed as the upper pouch 220 that wraps around the upper surface of the electrode assembly, and the other side may be formed as the lower pouch 210 that wraps around the lower surface of the electrode assembly.

One edge of the upper pouch 220 and one edge of the lower pouch 210 may be bent and overlapped to form the sealing portion 240. Here, the edges of the upper pouch and the lower pouch may correspond to the outer casing disposed in the opposite direction (the left direction of the partition plate in FIG. 3) of a direction in which the partition plate 300 faces the electrode assembly (the right direction of the partition plate in FIG. 3).

The partition plate 300 may be disposed so that an upper end contacts the upper pouch 220 and a lower end contacts the lower pouch 210. The partition plate 300 may be formed of a rigid material, which allows the upper pouch 220 and the lower pouch 210 to maintain their shapes even at the position at which the partition plate 300 is disposed. Accordingly, the upper pouch 220 and the lower pouch 210 may be maintained in a shape spaced apart from each other without being distorted.

The partition plate 300 may be fixedly disposed in a certain region inside the pouch case 200. For example, a bonding agent may be provided at the upper or lower end of the partition plate 300 to fix the partition plate 300, and the partition plate 300 may be bonded to the upper pouch 220 or the lower pouch 210 so as to be fixed. As another example, a hanging structure may be installed on the upper pouch 220 or the lower pouch 210 to fix the partition plate 300. A unit for fixing the partition plate 300 may be redisposed with other components without departing from the scope of the present disclosure.

The upper pouch 220 and the lower pouch 210 may be bent toward each other on the outer side of the partition plate 300 (the left side of the partition plate in FIG. 3). The upper pouch 220 and the lower pouch 210 may be bent at the upper and lower corners of the partition plate, respectively. The upper pouch 220 and the lower pouch 210 are provided long enough toward the outside of the partition plate 300, so that, the upper pouch and the lower pouch, after being bent, may overlap each other in a predetermined region to form the sealing portion 240.

When a surface of the upper pouch 220 and the lower pouch 210 facing the electrode assembly is referred to as an inner surface, and a surface exposed to the outside is referred to as an outer surface, the outer surface of one selected from among the upper pouch 220 and the lower pouch 210 and the inner surface of the other remaining one may be in contact with each other and overlap to form the sealing portion 240. In FIG. 3, the inner surface of the upper pouch 220 and the outer surface of the lower pouch 210 are shown to be in contact with each other and overlap, but conversely, it is also possible for the inner surface of the lower pouch 210 and the outer surface of the upper pouch 220 to be in contact with each other and overlap.

The sealing portion may be formed at a portion in which the inner surface of one of the upper and lower pouches and the outer surface of the other remaining one overlap in contact with each other, so that the sealing portion 240 may face one surface of the partition plate 300. That is, the sealing portion may not be formed to protrude in an outer direction of the pouch case (a horizontal direction of FIG. 3), but may be formed parallel to a height direction of the electrode assembly (a vertical direction of FIG. 3).

Therefore, according to an example of the present disclosure, the secondary battery having a high energy density may be provided without an additional folding process of the sealing portion, thereby providing the advantage of improved energy density and improved processability.

The sealing portion 240 may be sealed to seal the inside of the pouch case 200. The sealing may be performed, for example, by thermally fusing the region in which the upper and lower pouches overlap or by providing a bonding agent in at least a portion of the region in which the upper and lower pouches 22- and 210 overlap and bonding them to each other. The bonding agent may be formed of a material including, for example, polyvinylidene fluoride (PVDF).

Meanwhile, the partition plate 300 may be formed of a rigid material, so that the partition plate 300 may serve as a kind of guide to enable the upper pouch and the lower pouch to be stably bent. Accordingly, the upper pouch 220 and the lower pouch 210 may be stably bent at the corners of the partition plate 300.

The partition plate 300 may be formed of a plate shape having a predetermined thickness. The partition plate 300 may be configured to have a predetermined thickness so as to be stably positioned within the pouch case 200. However, since it may be desirable to manage the partition plate 300 below a predetermined thickness range from the viewpoint of the energy density of the secondary battery, the thickness of the partition plate 300 may be appropriately designed and changed by considering both structural stability and energy density.

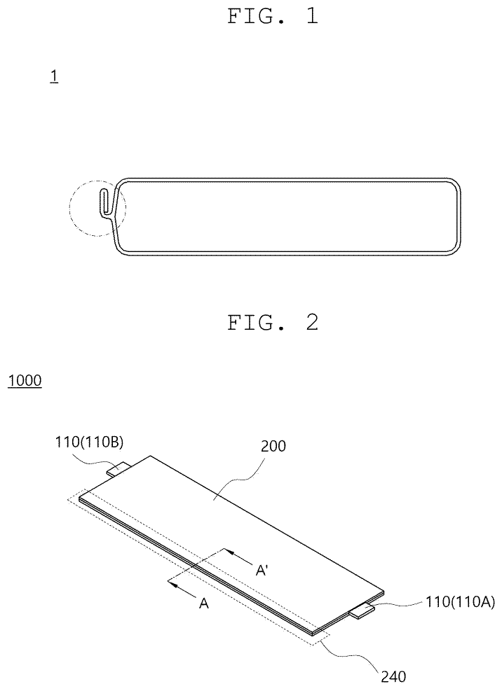

For example, the thickness of the partition plate 300 may be about 1 mm or more and 3 mm or less, or 1.5 mm or more and 2.5 mm or less. In the case of the related art pouch-type secondary battery as shown in FIG. 1, the thickness of the folded portion protruding outward from the pouch is managed to be about 2 mm. Therefore, when the thickness of the partition plate 300 is configured to be about 2 mm or less according to an exemplary embodiment of the present disclosure, the energy density of the secondary battery may be maintained while the processability may be improved.

Meanwhile, since the upper pouch 220 and the lower pouch 210 are bent on the outside of the partition plate 300, the sealing portion 240 may be formed to face one side of the partition plate 300. Therefore, when the sealing portion 240 is pressed to seal the sealing portion 240, the partition plate 300 may serve as a support to stably apply pressure to the sealing portion 240, thereby allowing the sealing portion to achieve sufficient sealing strength.

When the height of the pouch case 200 is H, the length of the sealing portion 240 in the height direction may be 0.5H or more and 1.0H or less, or 0.5H or more and 0.75H or less. By sufficiently securing the length of the sealing portion 240 to be 0.5H or more, the pouch case 200 may be stably sealed.

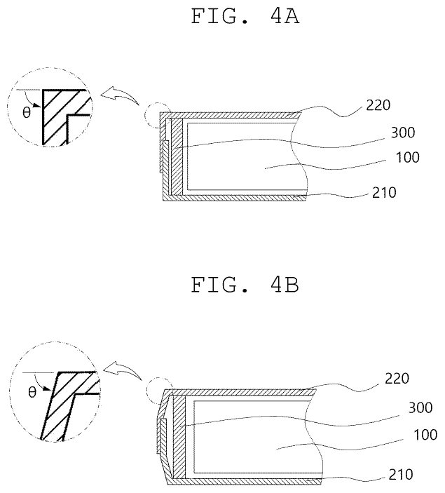

Hereinafter, an angle at which the upper pouch and the lower pouch are bent according to an example of the present disclosure will be described with reference to FIG. 4A and FIG. 4B. FIG. 4A illustrates an example in which the upper pouch and the lower pouch are bent at about 90°, and FIG. 4B illustrates an example in which the upper pouch and the lower pouch are bent at about 70°.

According to an example of the present disclosure, the angle (θ) at which the upper pouch 220 and the lower pouch 210 are bent toward each other may be 60° or more and 90° or less. The upper pouch 220 and the lower pouch 210 may only be bent toward each other by e, and an additional folding process of bending close to 180° as in FIG. 1 may not be performed.

According to an example of the present disclosure, since the upper pouch and the lower pouch are not excessively bent, the stress applied to the pouch may be relatively low. In addition, since the formation of cracks in the pouch may be prevented, the secondary battery with improved stability may be provided.

According to an example of the present disclosure, when the angle (θ) of the bending is 90° or less, a predetermined space may be formed between the sealing portion 240 and the partition plate 300.

The space may provide a free space in which the pouch case may expand when the internal pressure of the pouch case increases. This may contribute to preventing expansion of or damage to the pouch case and improving the internal pressure characteristics.

Hereinafter, the partition plate 300 of the present disclosure will be described with reference to FIG. 5. The partition plate 300 may have a plurality of micro-holes formed in a pattern. Gas may pass through the micro-holes, but liquid may not.

According to an example of the present disclosure, gas may pass through the partition plate 300, so that even if the partition plate 300 is inserted into the pouch case 200, a degassing process of removing gas inside the pouch case may be performed. Meanwhile, since a liquid cannot pass through the partition plate 300, an electrolyte inside the pouch case 200 may not leak to the sealing portion and the outside. For example, the size of the hole formed in the partition plate 300 may be formed to be 100 μm or more and 500 μm or less.

The existing degassing process is performed with the pouch completely opened without a separate partition plate, resulting in a phenomenon in which a portion of the electrolyte is scattered. According to an example of the present disclosure, even during the degassing process, the electrolyte may be physically blocked from the outside by the partition plate 300, so that the scattering amount of the electrolyte may be reduced, and thus the effective amount of the solution may be reduced, thereby providing a cost reduction effect.

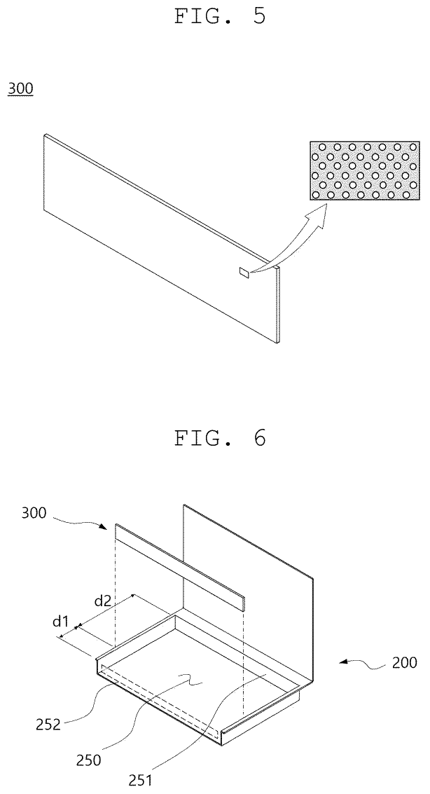

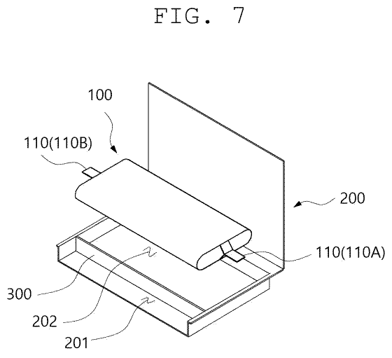

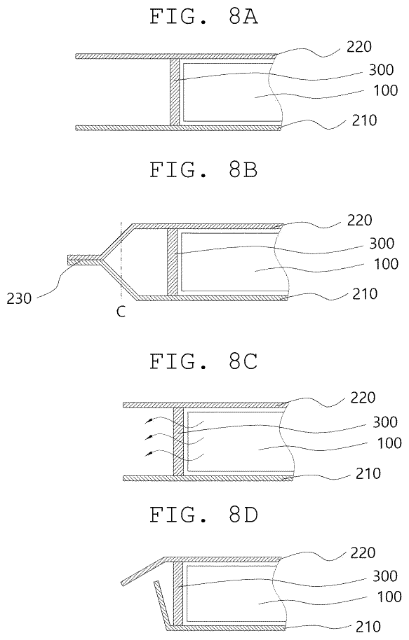

Hereinafter, a method for manufacturing a pouch-type secondary battery according to an example of the present disclosure will be described with reference to FIGS. 6 to 8D. FIGS. 6 and 7 are exploded perspective views of a pouch-type secondary battery, and FIGS. 8A to 8D is a cross-sectional view of each manufacturing stage of the pouch-type secondary battery as viewed from the A-A′ section of FIG. 2.

The method for manufacturing a pouch-type secondary battery according to an example of the present disclosure may include an accommodating operation of accommodating an electrode assembly in a cup portion of a pouch case, a partition plate inserting operation of inserting a partition plate into the cup portion, a temporary sealing operation of temporarily sealing an edge of the pouch case located outside the plate to form a sealing portion, a cutting operation of cutting the sealing portion, a folding operation of bending the pouch case at the corner of the partition plate, and a sealing operation of sealing an overlapping region formed by bending the pouch case, and may further include a cup forming operation of forming the cup portion.

The cup forming operation and the cup accommodating operation will be described below with reference to FIGS. 6 and 7.

As shown in FIG. 6, the pouch case 200 according to an example of the present disclosure may include a cup portion 250 in which a portion is formed to be concave to accommodate an electrode assembly. The pouch case 200 may include the upper pouch 220 and the lower pouch 210 as described above, and the cup portion 250 may be formed in the lower pouch. The cup portion 250 may be formed by stretching a portion of the pouch case 200, and the process is hereinafter referred to as a forming process.

According to an example of the present disclosure, the cup portion 250 may be formed by unforming a portion of a side surface of the lower pouch and forming the remaining surface. For example, as shown in FIG. 6, the formed surface may be closed and the unformed surface may be formed to be open. For example, as shown in FIG. 6, the surface 252 may be unformed and open.

Hereinafter, the operation of inserting the partition plate will be described. According to an example of the present disclosure, a partition plate 300 may be inserted into the cup portion 250, and the partition plate 300 may be disposed adjacent to an open surface 252 of the cup portion 250 and may be disposed in a direction parallel to the open surface 252.

For example, as shown in FIG. 6, the partition plate 300 may be disposed so as to maintain a gap d1 with the unformed surface, which is the open surface 252 and a gap d2 with the formed surface, which is the opposite surface 251 of the open surface 252. For example, the gap d1 and the gap d2 may satisfy d1<d2.

According to an example of the present disclosure, when the partition plate 300 is inserted into the pouch case 200, the space of the cup portion 250 may be divided into an outer side 201 and an inner side 202 by the partition plate 300. The electrode assembly 100 may be accommodated in the inner side 202 such that a direction in which the electrode tab 110 protrudes and a direction in which the partition plate 300 is disposed are parallel.

Based on the partition plate 300, the direction of the portion in which the electrode assembly 100 is accommodated is referred to as the inner side of the partition plate 300, and the opposite direction is referred to as the outer side of the partition plate 300. According to an example of the present disclosure, the pouch case 200 may include the upper pouch 220 that surrounds the upper surface of the electrode assembly 100 and the lower pouch 210 that surrounds the lower surface of the electrode assembly 100. For example, as shown in FIG. 8A, the upper pouch and the lower pouch may not be bonded, so that the outer side of the partition plate 300 may be open.

Hereinafter, the temporary sealing operation will be described. According to an example of the present disclosure, the pouch case 200 on the outer side of the partition plate 300 may be temporarily sealed as shown in FIG. 8B, which is referred to as a temporary sealing operation. The temporary sealing portion 230 may be formed through the temporary sealing operation.

The term “temporary sealing” used in the present disclosure is a concept that is distinct from sealing in the sealing operation described below (hereinafter, also referred to as main sealing to be distinguished from temporary sealing), and may refer to provisional sealing. According to an example of the present disclosure, the temporary sealing may have a weaker sealing strength than the main sealing, but the region formed between the temporary sealing portion 230 and the partition plate 300 may function as a gas chamber, thereby preventing the electrolyte from leaking during a formation process.

According to an example of the present disclosure, after the temporary sealing operation, the temporary sealing portion may be cut and removed, which is referred to as a cutting operation. For example, referring to FIG. 8B, the cutting line may be illustrated as a C line. For example, FIG. 8C may illustrate an appearance in which the temporary sealing portion is cut and removed.

According to an example of the present disclosure, the partition plate 300 may be gas permeable. For example, when the temporary sealing portion is cut and removed, gas inside the inner side 202 may pass through the partition plate 300 and be discharged to the outside. For example, when the temporary sealing portion is cut and removed, a degassing operation may be performed to remove gas generated after the electrode assembly 100 is accommodated in the inner side 202. However, the partition plate 300 may have gas permeability and liquid impermeability, and the electrolyte accommodated in the accommodation portion may not leak to the outside by the partition plate 300.

As shown in FIG. 8D, the method for manufacturing a pouch-type secondary battery according to an example of the present disclosure may include a folding operation in which the pouch case 200 is bent on the outside of the partition plate 300 and may include a sealing operation (not shown) in which the pouch case 200 is bent to seal a region in which the pouch case 200 overlaps.

Specifically, in the folding operation, the upper pouch 220 and the lower pouch 210 may be bent toward each other so that predetermined regions of each of the upper pouch 220 and the lower pouch 210 may overlap. For example, the upper pouch 220 may be bent at an upper corner of the partition plate 300, and the lower pouch 210 may be bent at a lower corner of the partition plate 300.

In addition, for example, the outer surface of one selected from the upper pouch 220 and the lower pouch 210 and the inner surface of the other remaining one may be bent to contact each other to form an overlapping region, and then the overlapping region may be mainly sealed.

According to an example of the present disclosure, in the folding operation, the angle at which the upper pouch and the lower pouch are bent may be 60° or more and 90° or less.

According to an example of the present disclosure, when the pouch case is folded to form an overlapping region, the corresponding region may be sealed. For example, the sealing here (hereinafter referred to as main sealing) may have a stronger sealing strength than the aforementioned gas sealing. For example, the region between the temporary sealing portion 230 formed by temporary sealing and the partition plate 300 may serve as a gas chamber and may not be provided to seal the electrode assembly by isolating it from the outside. In this case, the sealing strength of the gas sealing may be a strength smaller than that of the main sealing. As another example, the main sealing may have a predetermined sealing strength that is a strength able to finally seal the electrode assembly and may have a sealing strength greater than the sealing strength of the temporary sealing.

According to an example of the present disclosure, the main sealing may be performed by thermally fusing the region in which the pouch cases overlap and may be performed by using a bonding agent in the region in which the pouch cases overlap. For example, the main sealing may be performed by providing a bonding agent in at least a portion of the region in which the upper pouch 220 and the lower pouch 210 overlap and bonding them to each other.

As described above, by manufacturing the secondary battery, the secondary battery with a high energy density may be provided without an additional folding process, so that the energy density of the secondary battery may be improved and the processability may be improved. In addition, since the pouch is not excessively bent, cracks due to folding may be prevented, so that the secondary battery with improved stability may be provided.

According to an exemplary embodiment of the present disclosure, cracks in the folded portion may be prevented, thereby improving the mechanical stability of the secondary battery. In addition, the energy density of the secondary battery may be improved by minimizing the volume occupied by the folded portion. In addition, the productivity of the secondary battery may be improved by minimizing the forming process of the pouch case.

The effects of the present disclosure are not limited to the effects described above, and effects not mentioned may be clearly understood by those skilled in the art to which the present disclosure pertains from this specification and the accompanying drawings.

Although the exemplary embodiments of the present disclosure have been described above with reference to the accompanying drawings, those skilled in the art to which the present disclosure pertains will understand that the present disclosure may be implemented in other specific forms without changing the technical idea or essential features thereof. Therefore, the exemplary embodiments described above should be understood as being exemplary and not limiting in all respects.

### DETAILED DESCRIPTION OF MAIN ELEMENTS

1000: Pouch-type secondary battery
100: Electrode assembly
110 110A and 110B: Electrode tab
200: Pouch case
210: Lower pouch
220: Upper pouch
202: accommodation portion
201: sealing portion
250: cup portion
230: temporary sealing portion
240: sealing portion
300: partition plate

What is claimed is:

1. A pouch-type secondary battery comprising:
a pouch case accommodating an electrode assembly inside;
a sealing portion formed at an edge of the pouch case to seal the electrode assembly; and
a partition plate accommodated inside the pouch case, one surface of the partition plate facing the sealing portion and the other surface of the partition plate facing the electrode assembly,
wherein the pouch case is bent at a corner of the partition plate to form the sealing portion.

2. The pouch-type secondary battery of claim 1, wherein
the pouch case includes an upper pouch wrapping around an upper surface of the electrode assembly and a lower pouch wrapping around a lower surface of the electrode assembly, and
one edge of the upper pouch and one edge of the lower pouch are bent and then overlap each other to form the sealing portion.

3. The pouch-type secondary battery of claim 2, wherein the partition plate is disposed such that an upper end contacts the upper pouch and a lower end contacts the lower pouch.

4. The pouch-type secondary battery of claim 3, wherein
the upper pouch is bent at an upper corner of the partition plate,
the lower pouch is bent at a lower corner of the partition plate, and
the sealing portion is formed as an outer surface of one selected from the upper pouch and the lower pouch and an inner surface of the other one contact and overlap each other.

5. The pouch-type secondary battery of claim 4, wherein at least a portion of a region in which the upper pouch and the lower pouch overlap is provided with a bonding agent.

6. The pouch-type secondary battery of claim 4, wherein, when a height of the pouch case is H, a length of the region in which the upper pouch and the lower pouch overlap in a height direction is 0.5 H or more and 1.0 H or less.

7. The pouch-type secondary battery of claim 4, wherein an angle at which the upper pouch and the lower pouch are bent is 60° or more and 90° or less.

8. The pouch-type secondary battery of claim 1, wherein the partition plate has a plurality of holes formed in a pattern, and the plurality of holes are gas permeable or liquid impermeable.

9. A method for manufacturing a pouch-type secondary battery, the method comprising:
an accommodating operation of accommodating an electrode assembly in a cup portion of a pouch case;
a partition plate inserting operation of inserting a partition plate into the cup portion;
a temporary sealing operation of temporarily sealing an edge of the pouch case located outside the partition plate to form a temporary sealing portion;
a cutting operation of cutting the temporary sealing portion;
a folding operation of bending the pouch case at a corner of the partition plate; and
a sealing operation of sealing an overlapping region formed as the pouch case is bent.

10. The method of claim 9, wherein
the pouch case includes an upper pouch and a lower pouch, and
in the folding operation, the upper pouch is bent at an upper corner of the partition plate and the lower pouch is bent at a lower corner of the partition plate to form an overlapping region in which the upper pouch and the lower pouch overlap each other by a predetermined region, and
the overlapping region is formed as an outer surface of one selected from the upper pouch and the lower pouch and an inner surface of the other one are in contact with each other.

11. The method of claim 9, further comprising:
a degassing operation of degassing gas generated after the electrode assembly is accommodated after the cutting operation,
wherein the gas is discharged to the outside through the partition plate.

12. The method of claim 11, wherein the partition plate has a plurality of holes formed in a pattern, and the holes are gas permeable or liquid impermeable.

13. The method of claim 10, wherein, in the folding operation, an angle at which the upper pouch and the lower pouch are bent is 60° or more and 90° or less.

14. The method of claim 10, further comprising:
a cup forming operation of forming a cup portion in which the electrode assembly is seated in the lower pouch,
wherein, in the cup forming operation, the cup portion is formed by unforming one surface of the lower pouch and forming the remaining surface, and
in the partition plate inserting operation, the partition plate is disposed adjacent to the unformed surface of the lower pouch.
